(19) United States
(12) Patent Application Publication
(10) Pub. No.: US 2019/0224823 A1
(43) Pub. Date: Jul. 25, 2019

(54) HAND-HELD PRESSING DEVICE

(71) Applicant: Von Arx AG, Sissach (CH)

(72) Inventors: Matthias RUCH, Efringen-Kirchen (DE); Rudolf KREUZER, Buchs (CH)

(21) Appl. No.: 16/253,401

(22) Filed: Jan. 22, 2019

(30) Foreign Application Priority Data
Jan. 22, 2018 (EP) EP 18152681.5

(51) Int. Cl. B25B 27/14; B25B 7/04; B25B 27/10; H01R 43/042

(52) U.S. Cl. CPC B25B 27/146; B25B 7/04; B25F 5/00; H01R 43/0421; B25B 27/10

(57) ABSTRACT

A hand-held pressing device is described. The pressing device can be used for crimping or cutting workpieces. The device has a housing and a tool holder for receiving a tool. A movably configured actuator is driven by an electric motor to actuate the tool. The device includes a planetary gear assembly for coupling an electric motor and the actuator.

### CROSS REFERENCES TO RELATED APPLICATIONS

This application claims priority from EP application serial No. 18152681.5 filed on Jan. 22, 2018.

### FIELD

The present invention relates to hand-held pressing devices, in particular for the crimping or cutting of workpieces, and in particular for the machining of tubular workpieces. In particular, the pressing device according to the invention is suitable for connecting pipes with a press fitting by pressing, but is not limited thereto.

### BACKGROUND

In particular, hydraulically operated pressing devices are previously known from the prior art, in which an actuating element embodied as a piston can be moved back and forth in a hydraulic cylinder in order to perform work. When pressure is applied to the hydraulic cylinder, the piston is moved forward with great force and actuates, for example, a tool received at the head of the pressing device.

A typical representative of such hydraulic pressing devices is previously known from EP 0 712 696 A1. This pressing device has a fork-shaped receptacle in which a replaceable tool head, such as a pair of pliers or the like, can be accommodated. In the housing of the pressing device, an electric motor is arranged, which drives a hydraulic pump. The hydraulic pump, in turn, acts on a piston which is linearly movable on the housing and serves as an actuator for actuating the actual tool, such as a pair of pliers or the like. The use of a hydraulic drive unit has the advantage that very large forces can be generated with a relatively small structure and a reliable construction. The disadvantage, however, is that such devices are relatively expensive to maintain, because, for example, seals must be replaced regularly to prevent leakage of oil.

From EP 2 135 709 A2 of the same applicant, a further hydraulic pressing device is previously known, in which an electric motor drives a hydraulic pump, which in turn acts on a hydraulic piston-cylinder unit. On the housing, an actuating element in the form of a roller holder is provided. Two rollers act upon the linear movement of the actuating element on a tool. The tool is changeably held in a tool holder of the pressing device. The electric motor drives a hydraulic pump and is connected to a transmission. In the embodiment shown, a conventional planetary gear is proposed for this purpose. The planetary gear serves exclusively to reduce the rotational speed of the electric motor and transmits the rotation of the electric motor to a rotating eccentric shaft, which in turn drives the pump for the hydraulic fluid.

The previously known solutions have in common that they all act hydraulically. The electric motor serves as a drive for a hydraulic pump, which in turn pressurizes a hydraulic fluid to linearly move an actuator on the housing.

It is an object of the present invention to provide a hand-held pressing device which is reliable and safe to handle and manages without hydraulic elements. In particular, it is an object to provide a pressing device in which a linear feed of an actuating element provided in the housing can take place via purely mechanical means. By dispensing with hydraulic elements, the maintenance of the pressing device is reduced considerably.

These and other objects will become apparent upon reading the following description, are achieved by a hand-held pressing apparatus as described herein.

### SUMMARY

The difficulties and drawbacks associated with previous approaches are addressed in the present subject matter as follows.

In one aspect, the present subject matter provides a hand-held pressing device comprising a housing, a tool holder for receiving a tool, and an actuating element mounted linearly movable on the housing. The actuating element is for actuating a tool received in the tool holder. The pressing device also comprises an electric motor for driving the actuating element, and a planetary gear assembly coupled to a shaft of the electric motor and mechanically coupled to the actuating element to linearly move the actuating element. The planetary gear assembly includes at least two elements arranged so as to be linearly movable relative to one another such that rotation of one element of the planetary gear leads to a linear movement of the other element of the planetary gear.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

In the following, the following invention will be described in detail with reference to the accompanying drawings.

FIG. 1 shows schematically a partial cross section of a hand-held pressing device according to the invention.

FIG. 2 is a schematic schematic diagram of the drive components.

FIG. 3 is a schematic three-dimensional external view of the pressing device.

FIG. 4 shows the view of FIG. 3 with an inserted tool head.

### DETAILED DESCRIPTION OF THE EMBODIMENTS

The invention relates to a hand-held pressing device, in particular for processing tubular workpieces, such as by crimping or cutting. The pressing device comprises a housing and a tool holder for receiving a tool. The tool holder is preferably set up for exchangeable reception of different types of tools, such as crimping tools, hole punches or the like. However, the tool holder can also be fixedly coupled or connected or integrally formed with a tool. To actuate a tool accommodated in the tool holder, an actuating element is designed to be linearly movable on the housing. Further, the pressing device comprises an electric motor for driving the actuating element, that is, in order to move the actuating element. For this purpose, a planetary gear or gear assembly is provided, which is arranged on the input side to the shaft of the electric motor, directly or indirectly, and coupled on the output side mechanically, preferably directly coupled to the actuating element to move the actuator linearly. A feature of the planetary gear assembly according to the invention is that at least two elements of the planetary gear assembly are arranged linearly relative to each other and movable, in such a way that a rotation of an element of the planetary gear assembly leads to a linear movement of another element of the planetary gear assembly.

The basic mode of operation of planetary gears is known to a person skilled in the art. Planetary gears are also referred to as planet gears and have as a special feature that the input and output shafts are arranged parallel to each other. Planetary gears are typically used to induce speed differences. In the cited prior art a planetary gear, for example, is utilized to implement the design-related high speeds of the electric motor suitable for the lower rotational speeds of the hydraulic unit. The planetary gear is thus used exclusively for transmitting rotational movements. However, the planetary gear proposed in the present invention is designed such that the rotation of the electric motor leads to a linear movement of an element of the planetary gear assembly, so that this linear movement of the element of the planetary gear can serve to move the actuating element. In the simplest case, this can for example be achieved in that the ring gear of the planetary gear is held immovable linearly, but rotatably in the housing and the sun gear is rotatable and linearly arranged. By choosing a suitable helical gear, for example, transmitted from the ring gear (via the planet gears) rotational movement can lead to a linear movement of the sun gear.

The housing of the pressing device is preferably at least partially made of a plastic, in particular of a thermoplastic material. The actuator may have any shape and structure that permits actuation of the tool. In particular, the actuating element can be connected to the tool or even integrally formed therewith. The terminology that the actuating element is movably arranged “on” the housing includes many different constructive solutions and in particular also solutions in which the actuating element is arranged outside the housing, within the housing or mixed forms thereof.

Preferably, the shaft of the electric motor and the central shaft of the planetary gear are arranged in parallel. A parallel arrangement of the two relevant components facilitates the coupling of the electric motor with the planetary gear assembly.

More preferably, the two components are arranged parallel to each other. A parallel, juxtaposed arrangement allows a particularly compact design of the pressing device. For example, it is thus possible that the components, i.e., the electric motor and planetary gear assembly are not arranged linearly one behind the other, but next to each other, whereby the length of the pressing device can be advantageously reduced. A short length is advantageous because when using such pressing devices often only a limited space is available when, for example, pipes are to be processed in installation shafts with the pressing device. In principle, it is preferred that the two shafts are arranged at a distance of 5 to 30 cm, more preferably from 5 to 20 cm and even more preferably from 6 to 18 cm. These distances are the distance between the two parallel components to each other, the shortest distance between the imaginary axes of rotation of the components.

Preferably, the elements of the planetary gear assembly include a central sun gear member, a ring gear, and a plurality of planet gears which planetary gears are supported on a planet carrier. The central sun gear element and the planetary gears are arranged within the ring gear and meshed with each other via corresponding teeth, so that, for example, a rotation of the ring gear can be transmitted to the planetary gears and transferred from these to the sun gear element. This classic design for a planetary gear provides a robust and safe implementation of the principle of the invention.

Preferably, of the elements, the sun gear and the ring gear are arranged linearly relative to each other movable and stored such that either the ring gear or the sun gear is linearly immovable in the housing. For example, the ring gear can be mounted linearly movable in the housing, i.e., in the direction of its axis of rotation, whereas the sun gear is rotatably but linearly immovably mounted in the housing. In such a configuration, the electric motor would be coupled to the sun gear element and would drive the sun gear element in rotation. The rotational movement of the sun gear is transmitted through the planet to the ring gear. With a suitable internal toothing of the ring gear, such as a suitable helical toothing, the rotational movement of the planet gear leads to a linear feed of the ring gear. This linear feed is then used to move the planetary gear mechanically coupled to the actuator linearly.

Further preferably, the planetary gear is arranged in the housing such that rotation of the sun gear element results in a relative linear movement of the ring gear, or that rotation of the ring gear results in a relative linear movement of the sun gear element. This can be effected for example by suitable helical gears on the various elements.

Preferably, the ring gear is rotatable but more linearly journaled within the housing and rotation of the ring gear results in a relative linear movement of the sun gear member and the sun gear member is connected to the actuator for linear movement thereof. The sun gear element may, for example, be connected to the actuating element via further mechanical means, or be fastened thereto or formed integrally. A movement of the sun gear elements due to the rotation of the ring gear, which is driven in this case by the electric motor, thus leads to a linear movement of the actuating element and thus can actuate a tool which is received in the tool holder. This configuration is particularly preferred, since the sun gear element is located centrally in the center of the planetary gear assembly and is preferably aligned parallel to the direction of movement of the actuating element. Thus, the linear movement of the sun gear member directly leads to a corresponding linear movement of the actuating element, i.e., 1/1.

Preferably, the sun gear element comprises a worm shaft. For this purpose, the sun gear element can itself be designed at least partially as a worm shaft or comprise a worm shaft as a separate or integral part. In particular, the sun gear element may consist of one or more parts of which it is composed. For example, it may be in the form of an elongate bolt and be provided with a worm thread only over part of its surface. A rotation of the ring gear causes movement about the planet gears so that, for example, a linear movement of the sun gear, when this is arranged to be linearly movable in the housing.

Preferably, the direction of movement of the actuating element and the axis of a worm shaft is arranged in parallel and particularly preferably arranged coaxially. A parallel arrangement, and in particular a coaxial arrangement, allows the direction of movement and axis of the worm shaft to be in line with each other, so that no further deflection of the worm shaft movement, when it is moved approximately linearly relative to a ring gear, must be made to drive the actuator.

In principle, it is preferred that a planetary gear is mechanically coupled directly to the actuating element. Direct mechanical coupling means in this case that no further implementations, gear, hydraulic components, etc., are provided between the corresponding element of the planetary gear, which moves linearly in the housing, and the actuating element. This results in a one-to-one movement of the element of the planetary gear to a corresponding movement of the actuating element.

Preferably, the shaft of the electric motor is connected to the planetary gear assembly via another gear and/or a belt. The coupling of electric motor and planetary gear on such further components allows, for example, arrangement of the electric motor next to the planetary gear, for example, such that the corresponding shafts of the electric motor and planetary gear are arranged parallel to each other. This offers over an aligned or arranged in a line configuration the advantage that the pressing device can be made shorter, which offers handling advantages. For example, the shaft of the electric motor can be connected to the corresponding element of the planetary gear via a toothed belt.

Preferably, the electric motor is a brushless motor. Still more preferably, the pressing apparatus comprises a controller arranged to detect, by means of one or more Hall sensors of the brushless electric motor, the speed of the motor and/or the number of revolutions of the motor. Brushless electric motors offer the advantage that they run very low maintenance and wear-free. In addition, with their Hall sensors, brushless electric motors offer the option of a suitable controller measuring the speed and the number of revolutions of the motor. Thus, it is possible to determine the movement of the linearly movable element of the planetary gear, and thus of the actuating element. In this way, a cost-effective way of determining the actuation path is possible, so that the actuating element is advanced only exactly as far as desired for the given application.

The pressing apparatus preferably includes a controller configured to detect the motor current and to stop the motor in response to a detected current value or a history or course of the motor current value. For example, increases when operating the tool, of the corresponding counteracting force acting on the actuator, also increases the force on the linearly movable member of the planetary gear assembly. This, in turn, leads to an increased driving torque of the non-linearly movable element of the planetary gear, which ultimately, by the coupling of planetary gear and electric motor, leads to an increase in the motor current that can be measured. In this way, the pressing operation can be monitored by the control device.

Further preferably, the planetary gear assembly is arranged such that a reversal of the motor rotation direction leads to a reversal of the linear direction of movement of the actuating element. In this way, after a completed operation, the actuator can be moved back to its original position by changing only the direction of motor rotation of the electric motor.

In principle, the pressing device preferably has a pistol grip. In this way, a particularly ergonomic handling of the pressing device is given. Particular advantages arise when the corresponding shafts of electric motor and planetary gear assembly are arranged parallel to each other, as a result, a very compact design is possible. The pistol grip provides safe handling of the device in such a compact design and allows even further shortening of the length of the device, since the trigger switch and in particular an optional battery for powering the device can be provided on the pistol grip.

The present invention basically has the advantage that no hydraulic components are needed. That is, the present pressing apparatus is preferably not a hydraulic pressing apparatus.

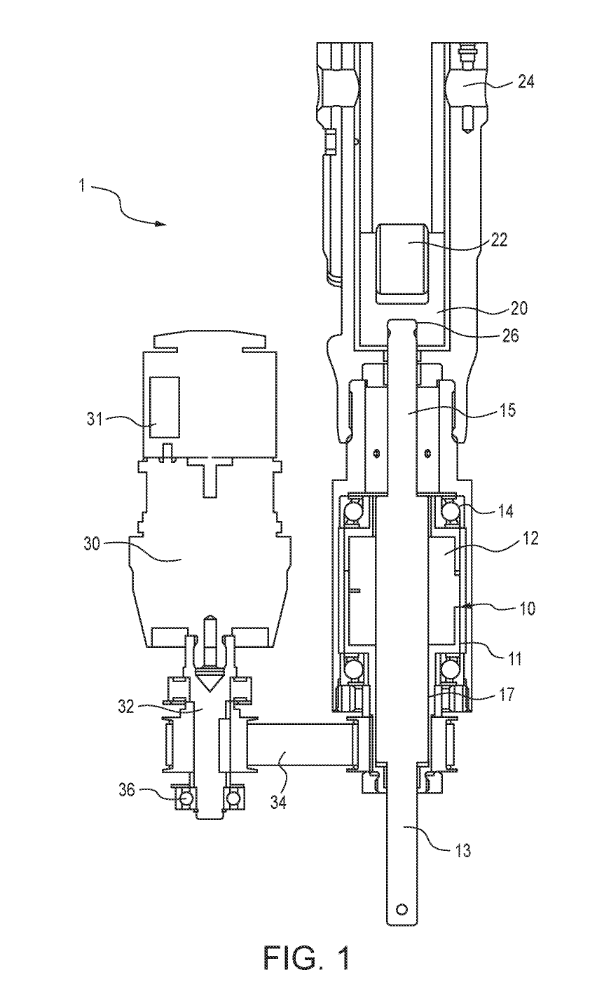

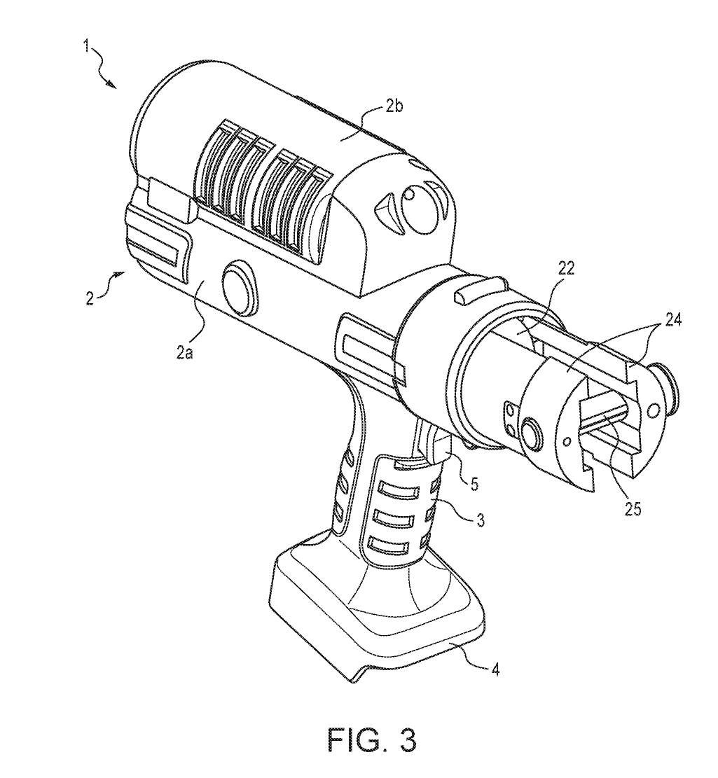

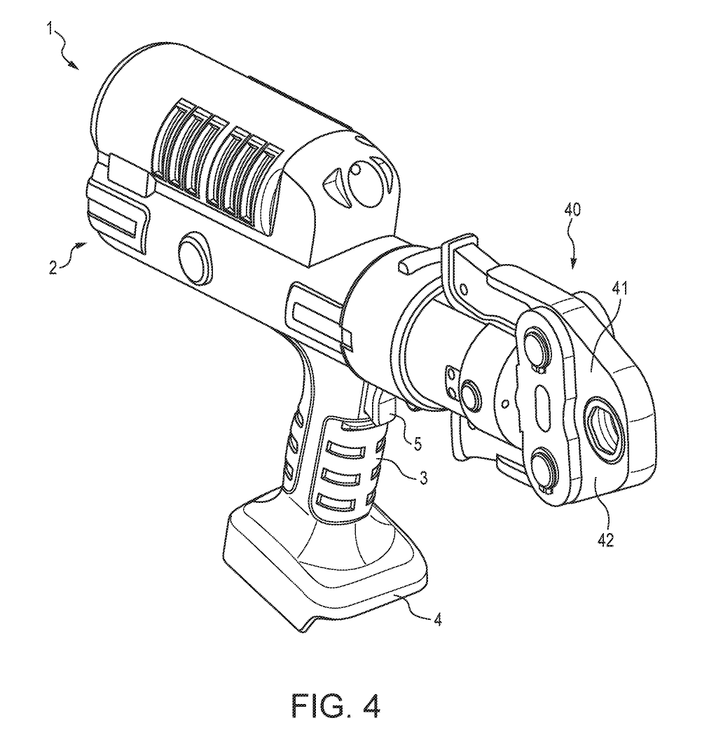

FIG. 1 shows a schematic, partially sectioned side view of a pressing device 1 according to the invention. The pressing device 1 comprises an electric motor 30 for driving a linearly mounted actuating element 20. The operation of the actuating element and the tool holder corresponds in principle to that of the cited document EP 0 712 696 A1, which is hereby incorporated by reference. The actuator 20 is guided in a fork-shaped tool holder 24 and can be linearly moved relative to a housing 2 (shown in FIGS. 3 and 4) back and forth. At the distal end, rollers 22 are provided for actuating a tool received in the tool holder (tool not shown). In the housing, a planetary gear assembly 10 is further provided. The planetary gear assembly 10 includes a ring gear 11 which is rotatably supported in the housing 2 via bearings 14. Centrally in the ring gear 11, a sun gear 13 is provided, which is operatively connected via one or more planet or planetary gears 12 with the ring gear 11. Generally, the planetary gear assembly 10 also includes a plurality of planetary gears 12.

The sun gear or sun gear member 13 is configured as a bolt which has a region with an enlarged cross section, which is provided with a worm gear or worm shaft 17. The sun gear member 13 thus includes a worm shaft integrally formed with the sun gear member 13. At one end there is a piston extension 15, which is inserted in a bore 26 in the actuating element 20. In this way, the actuator 20 is mechanically coupled with the planetary gear 10 directly, without mechanical or hydraulic deflections. The sun gear member 13 is arranged to be movable in a linear manner relative to the ring gear 11. Upon rotation of the ring gear 11, the planets 12 engage in the teeth of the worm gear 17 and since the sun gear member 13 is arranged to be linearly movable, thus the sun gear member 13 can be moved linearly. In other words, a rotation of the ring gear 11 leads to a relative linear movement of the sun gear member 13 and since the sun gear member 13 is connected to the actuator 20, this is moved linearly. It can be seen from the figure that the direction of movement of the actuating element and the axis of the sun gear member 13 and the worm shaft 17 are arranged parallel to the direction of movement of the actuating element and are actually arranged coaxially. In this way, a linear movement of the sun gear 13 is transferred directly and directly into a linear movement of the actuator 20. In many embodiments, one of the ring gear and the sun gear is linearly immovable relative to a housing of the pressing device. Typically, the planetary gear assembly is disposed within the housing of the pressing device. In many embodiments, the sun gear is connected to the actuating element, the ring gear is rotatably mounted and linearly immovable in the housing, and the ring gear and the sun gear are configured such that rotation of the ring gear results in relative linear movement of the sun gear and the actuating element connected thereto.

The shaft 32 of the electric motor 30 is coupled via a toothed belt 34 with the ring gear 11. Bearing 36, shaft 32 and belt 34 are covered by parts of the housing 2 in operation, which have been omitted herein for clarity. A rotation of the shaft 32 is converted via the belt 34 directly into a rotation of the ring gear 11. A reversal of the motor rotation direction leads directly to a reversal of the direction of rotation of the ring gear 11 and thus to a reversal of the linear direction of movement of the sun gear or the worm shaft 17. The pressing device 1 also has a controller 31.

It can be seen from FIG. 1 that the shaft 32 of the electric motor and the central shaft of the planetary gear, that is, in the present case, the shaft of the sun gear 13, are arranged parallel to each other. The distance between the two shafts is in practice, for example, 20 cm, so that a compact design is possible.

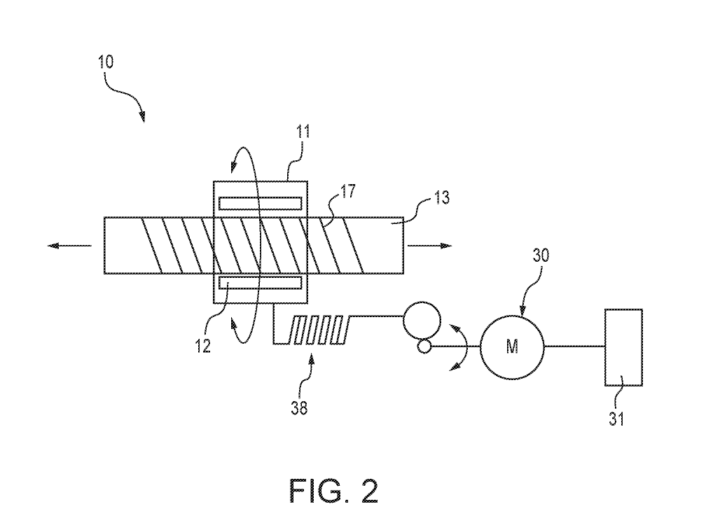

FIG. 2 shows a purely schematic representation of the operating principles of the drive. Here, the same reference numerals for the corresponding elements of FIG. 1 are used. The planetary gear assembly 10 has a rotatably mounted ring gear 11 which is connected via planet or planetary gears 12 with a centrally disposed sun gear 13 in operative connection. The sun gear member 13 has a worm shaft 17. The electric motor 30 is connected in the case shown in FIG. 2 via a deflection gear 38 to the ring gear 11, so that a rotation of the motor shaft of the electric motor 30 can be converted into a rotation of the ring gear 11. A transmission or belt, such as belt 34, or other power transfer component(s) can be used with or instead of the deflection gear 38. Due to the helical toothing of the worm shaft 17 and a suitable mounting, the sun gear member 13 is designed to be movable in a linear manner relative to the ring gear 11. A change in the direction of rotation of the motor 30 leads to a change in the direction of rotation of the ring gear 11 and thus to a change in the linear direction of movement of the sun gear 13.

FIG. 3 shows a schematic, three-dimensional view of the pressing device 1. The pressing device has a housing 2, which is typically made of plastic. The device has a pistol grip 3, on which a trigger switch 5 is provided. At the free or distal end of the pistol grip 3, a receptacle 4 for a battery (not shown) is provided for the power supply of the device. In this way, a very compact device is provided, which in particular advantageously has a small length. The housing 2 has a cylindrical base body 2a, in which the planetary gear assembly 10 is set up. The electric motor 30 is located parallel to the planetary gear in an attachment 2b of the housing.

From the front end of the housing 2, the fork-like tool holder 24 extends, in which the actuating element 20 is guided with the rollers 22. The tool holder 24 must therefore be correspondingly stable and is made of metal, in particular an aluminum alloy or steel. At the distal end of the tool holder 24, a releasable bolt 25 is provided. This bolt allows the attachment of tool heads, so that they can be fixed immovably relative to the device.

In FIG. 4, the view of FIG. 3 is shown again, wherein here a tool head 40 is held in the tool receptacle 24 of the pressing device 1. The tool head 40 shown is a crimping tool with two pressing jaws 41 and 42 arranged to be movable relative to one another. When the trigger switch 5 is actuated, the electric motor 30 drives the planetary gear assembly 10, and the piston extension 15 moves the actuating element 20 and the rollers 22 in the direction of the distal end of the tool holder 24. When the rollers 22 come into contact with the rear lever arms of the pressing jaws, the levers are moved away from each other outwards and the crimping tool closes, for example, to press a fitting.

LIST OF REFERENCE NUMBERS

| | |
|---|---|
| 1 | Pressing unit |
| 2 | Housing |
| 2a | Base body |
| 2b | Attachment body |
| 3 | Pistol grip |
| 4 | Receptacle for battery |
| 5 | Trigger switch |
| 10 | Planetary gear assembly |
| 11 | Ring gear |
| 12 | Planet gear(s) |
| 13 | Sun gear |
| 14 | Bearing(s) |
| 15 | Piston extension |
| 17 | Worm/gear/worm wheel |
| 20 | Actuator |
| 22 | Rollers |
| 24 | Tool holder |
| 25 | Bolts for tool attachment |
| 26 | Bore |
| 30 | Electric motor |
| 31 | Controller |
| 32 | Shaft of the electric motor |
| 34 | Belt |
| 36 | Bearing(s) |
| 38 | Deflection gear |
| 40 | Tool head |
| 41, | Pressing jaws |
| 42 | |

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. Hand-guided pressing device, in particular for crimping or cutting workpieces, comprising:
a housing, which is preferably made of plastic;
a tool holder for receiving a tool;
an actuating element mounted linearly movable on the housing, the actuating element for actuating a tool received in the tool holder;
an electric motor for driving the actuator; and
a planetary gear, which on the input side is coupled to the shaft of the electric motor and the output side mechanically coupled to the actuating element to linearly move the actuating element, wherein at least two elements of the planetary gear are arranged linearly movable relative to each other, so that a rotation of one element of the planetary gear leads to a linear movement of another element of the planetary gear.

2. The pressing device according to claim 1, characterized in that the shaft of the electric motor and the central shaft of the planetary gear are arranged in parallel.

3. The pressing device according to claim 2, characterized in that the two shafts are arranged parallel to each other and preferably the two shafts are arranged at a distance of 5 to 30 cm, more preferably from 5 to 20 cm and more preferably from 6 to 18 cm.

4. The pressing device according to claim 1, characterized in that the elements of the planetary gear comprise a central sun gear member, a ring gear and a plurality of planet wheels, which planet gears are supported on a planet carrier.

5. The pressing device according to claim 4, characterized in that the sun gear element and the ring gear are arranged linearly relative to each other movable and either the ring gear or the sun gear member is linearly immovable in the housing.

6. The pressing device according to claim 4, characterized in that the planetary gear is arranged in the housing 50 that a rotation of the sun gear leads to a relative linear movement of the ring gear or that a rotation of the ring gear leads to a relative linear movement of the sun gear member.

7. The pressing device according to claim 4, characterized in that the ring gear is rotatably but linearly immovably mounted in the housing and a rotation of the ring gear leads to a relative linear movement of the sun gear member and wherein the sun gear member is connected to the actuator to move it linearly.

8. The pressing device according to claim 5, characterized in that the sun gear element comprises a worm shaft.

9. The pressing device according to claim 8, characterized in that the direction of movement of the actuating element and the axis of the worm shaft are arranged in parallel and are preferably arranged coaxially.

10. The pressing device according to claim 1, characterized in that a shaft of the electric motor is connected with the planetary gear via a transmission and/or a belt.

11. The pressing apparatus according to claim 1, characterized in that the electric motor is a brushless motor, and further preferably, the pressing apparatus comprises a controller adapted to operate by means of Hall sensors of the brushless electric motor to detect the speed of the motor and/or the number of revolutions of the motor.

12. The pressing apparatus according to claim 1, characterized in that the pressing apparatus comprises a controller configured to detect the motor current and to stop the motor in response to a detected motor current value or a course of the motor current value.

13. The pressing device according to claim 1, characterized in that the planetary gear is arranged such that a reversal of the motor rotation direction leads to a reversal of the linear direction of movement of the actuating element.

14. The pressing device according to claim 1, characterized in that the pressing device is not a hydraulic pressing device.

15. The pressing device according to claim 1, characterized in that the pressing device has a pistol grip.
